(19) United States
(12) Patent Application Publication
(10) Pub. No.: US 2008/0106495 A1
(43) Pub. Date: May 8, 2008

(54) Plasma display panel and a method of preventing afterimage thereof

(75) Inventors: Young-ki Shon, Suwon-si (KR); Yoon Jung, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/730,606

(22) Filed: Apr. 3, 2007

(30) Foreign Application Priority Data
Nov. 3, 2006 (KR) 10-2006-0108163

(51) Int. Cl. G09G 3/28

(52) U.S. Cl. 345/60

(57) ABSTRACT

An apparatus of preventing an afterimage of a plasma display panel (PDP) and a method thereof are provided, which includes selecting at least one sub-field to insert an afterimage preventive pattern, among sub-fields of a plurality of frames of a video signal to be displayed, inserting the afterimage preventive pattern to the selected sub-field, and displaying on a display, the frame containing the sub-field in which the afterimage preventive pattern is inserted.

### CROSS-REFERENCE TO RELATED APPLICATIONS

This application claims priority under 35 U.S.C. §119 from Korean Patent Application No. 10-2006-0108163, filed on Nov. 3, 2006 in the Korean Intellectual Property Office, the disclosure of which is incorporated herein by reference in its entirety.

### BACKGROUND OF THE INVENTION

1. Field of the Invention

Apparatuses and methods consistent with the present invention relate to a plasma display panel and a method of preventing an afterimage, and more particularly, to preventing an afterimage from generating during playing of a video signal, by inserting an afterimage preventive pattern in a sub-field, or additionally inserting a sub-field having an after image preventing pattern.

2. Description of the Related Art

A plasma display panel (PDP) includes a plurality of fine phosphors. The PDP includes two glass plates, each having transparent electrode arrangements, and gas injected in between the glass plates. As a voltage is applied to the gas, radiation occurs, an ultraviolet ray is generated, and accordingly, phosphors are excited and emit light. There are generally three types of phosphor cells, red (R), green (G), and blue (B) cells, and almost the entire color gamut is realizable.

The phosphors at the partition of the cells may wear out if a still image is displayed for a long period of time, and ghosts (afterimages) are generated between the bright and dark areas. Once generated, the afterimages deteriorate the motion picture quality considerably.

In order to remove the afterimages, many different methods have been proposed, such as Obiter, White wash, and Inversion.

The Obiter removes afterimages by moving the currently displayed image, along with adjusting the size of the displayed image by use of scaler. However, eye fatigue and subsequent inconvenience may be caused when the image is moved.

The White wash causes the entire area of the display panel to radiate in a white light, and therefore, the image turns invisible during the White wash.

The Inversion inverts the color of the currently displayed image to an opposite color, and therefore, viewers cannot see the image in its original color during the Inversion.

As explained above, the ways currently available to remove afterimages cause viewer inconvenience or inefficient display of video signal. Accordingly, an improved method for preventing afterimages, and providing improved user convenience and intact video signal display quality, is necessary.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a plasma display panel (PDP) and a method of preventing afterimage of the PDP, which removes afterimage of a video signal being displayed and prevents user inconvenience, by inserting an afterimage preventive pattern in a sub-field, or additionally inserting a sub-field having the afterimage preventive pattern.

An aspect of the present invention provides a method of preventing an afterimage of a plasma display panel (PDP), the method comprising: selecting at least one sub-field to insert an afterimage preventive pattern, among sub-fields of a plurality of frames of a video signal to be displayed, inserting the afterimage preventive pattern to the selected sub-field, and displaying on a display, the frame containing the sub-field in which the afterimage preventive pattern is inserted.

The selecting at least one sub-field may comprise selecting the at least one sub-field according to a specified time period.

The selecting at least one sub-field may comprise selecting the sub-field randomly.

The selecting the at least one sub-field may comprise: generating a signal to select the sub-field according to a specified time period, measuring a time to the next signal, if the signal is generated, determining if the measured time exceeds a specified time, and selecting the sub-field at the moment that the signal is generated, if the measured time exceeds the specified time.

Selecting the sub-field after the specified time elapses, may be further provided, if the measured time does not exceed the specified time.

Another aspect of the present invention provides a method of preventing an afterimage of a plasma display panel (PDP), the method comprising: selecting a location within a frame to insert an afterimage preventive pattern, from a plurality of frames of a video signal to be displayed, inserting a sub-field having the afterimage preventive pattern to the selected location, and displaying on a display, the frame in which the sub-field having the afterimage preventive pattern is inserted.

The selecting the location to insert the afterimage preventive pattern may comprise selecting the location every time a specified time elapses.

The selecting the location to insert the afterimage preventive pattern may comprise: generating a signal to select a location to insert the sub-field, according to a specified time period, measuring a time to the next signal, if the signal is generated, and selecting a location to insert the sub-field, if the measured time exceeds the specified time period.

Selecting a location to insert the sub-field at a time that the measured time reaches the predetermined time period, may be further provided, if the measured time does not exceed the predetermined time period.

Yet another aspect of the present invention provides a plasma display panel (PDP), comprising: a sub-field selector which selects at least one sub-field to insert an afterimage preventive pattern, among sub-fields of a plurality of frames of a video signal to be displayed, a pattern inserter which inserts the afterimage preventive pattern to the selected sub-field, and a display which displays the frame containing the sub-field in which the afterimage preventive pattern is inserted.

The sub-field selector may select the at least one sub-field according to a specified time period.

The sub-field selector selects the at least one sub-field randomly.

The PDP may further comprise a signal generator which generates a signal to select the sub-field according to a specified time period, and a timer which measures a time from the generation of the signal until the next signal, and wherein the sub-field selector, upon determination that the signal is generated from the signal generator, selects the sub-field if the measured time exceeds the specified time, and selects the sub-field after the specified time elapses, if the measured time does not exceed the specified time.

A memory may be further provided, which stores the afterimage preventive pattern, such that the pattern inserter inserts the afterimage preventive pattern being stored in the memory into the selected sub-field and provides the display with the afterimage preventive pattern.

The afterimage preventive pattern may comprise at least one of a full white (F/W) pattern in which the entire screen is represented in white, a red, green, blue (RGB) alternating pattern in which red, green and blue are alternatively expressed, and a company logo pattern.

Yet another aspect of the present invention provides a plasma display panel (PDP), comprising: a location selector which selects a location to insert a sub-field having an afterimage preventive pattern, from at least one of a plurality of frames of a video signal to be displayed, a sub-field inserter which inserts the sub-field having the afterimage preventive pattern into the selected location, and a display which displays the frame in which the sub-field having the afterimage preventive pattern is inserted.

The location selector may select the location to insert the sub-field, according to a specified time period.

The location selector may select the location to insert the sub-field, randomly.

The PDP may further comprise a signal generator which generates a signal to select the location to insert the sub-field having the afterimage preventive pattern, according to a specified time period; and a timer which measures a time until the next signal, if a signal is output from the signal generator, such that the location selector, upon determination that the signal is generated from the signal generator, selects the location to insert the sub-field having the afterimage preventive pattern, if the measured time exceeds the specified time, and waits until the specified time elapses and selects the location to insert the sub-field having the afterimage preventive pattern, if the measured time does not exceed the specified time.

### BRIEF DESCRIPTION OF THE DRAWINGS

The above and/or other aspects of the present invention will be more apparent by describing certain exemplary embodiments of the present invention with reference to the accompanying drawings, in which:

FIG. 1 is a block diagram of a plasma display panel (PDP) according to an exemplary embodiment of the present invention;

FIG. 2 illustrates an afterimage preventive pattern being inserted according to an exemplary embodiment of the present invention;

FIG. 3 is a block diagram of an afterimage preventing block according to an exemplary embodiment of the present invention;

FIG. 4 is a flowchart illustrating the process of preventing an afterimage, by inserting an afterimage preventive pattern according to an exemplary embodiment of the present invention;

FIG. 5 is a block diagram of an afterimage preventing block according to an exemplary embodiment of the present invention;

FIG. 6 illustrates a sub-field being inserted according to an exemplary embodiment of the present invention; and

FIG. 7 is a flowchart illustrating the process of preventing an afterimage, by inserting a sub-field according to an exemplary embodiment of the present invention.

### DETAILED DESCRIPTION OF THE EXEMPLARY EMBODIMENTS

Certain exemplary embodiments of the present invention will now be described in greater detail with reference to the accompanying drawings.

In the following description, the same drawing reference numerals are used for the same elements even in different drawings. The matters defined in the description, such as detailed construction and elements, are provided to assist in a comprehensive understanding of the invention. Thus, it is apparent that the present invention can be carried out without those specifically defined matters. Also, well-known functions or constructions are not described in detail since they would obscure the invention with unnecessary detail.

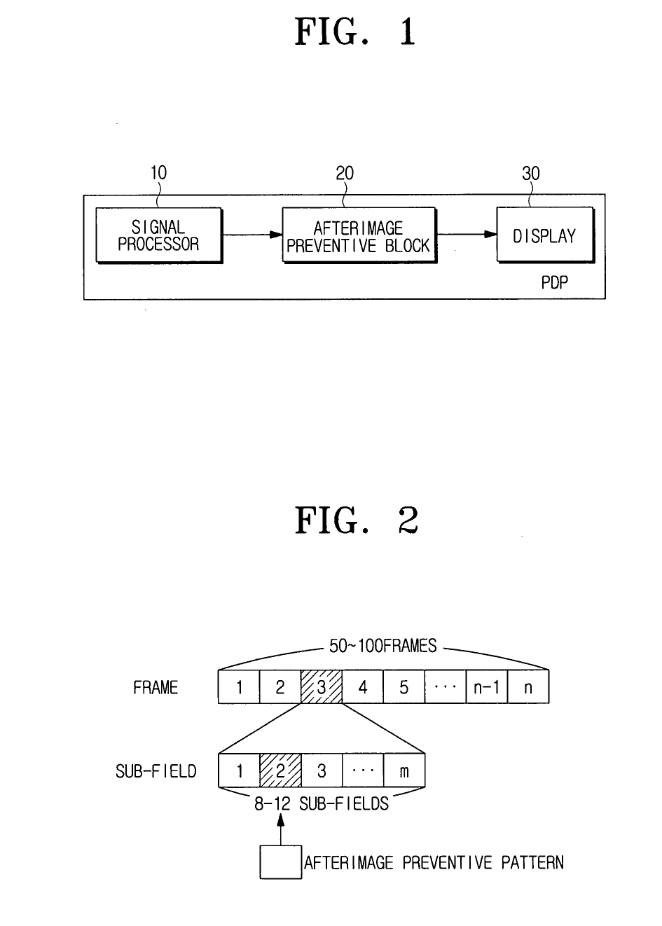

FIG. 1 is a block diagram of a plasma display panel (PDP) according to an exemplary embodiment of the present invention.

The PDP includes a signal processor 10, a display 30 and an afterimage preventive block 20.

The signal processor 10 processes incoming video signal using processing such as tuning and digitalization, to convert the video signal into a form available for output through the display 30.

The display 30 receives a video signal being processed at the signal processor 10, and displays a video.

A general PDP outputs 50 to 100 frames per second, and each frame includes 8 to 12 sub-fields. Accordingly, 400 to 1200 sub-fields are displayed through the display 30 in one second, and this can be expressed as 400 Hz to 1200 Hz.

The afterimage preventive block 20 prevents generation of afterimage in the display 30 during the output of the video signal, by inserting an afterimage preventive pattern, by directly insert afterimage preventive pattern in an existing sub-field, or additionally inserting a sub-field having the afterimage preventive pattern.

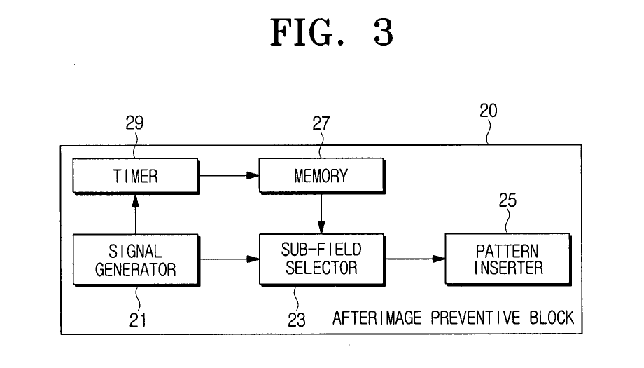

FIG. 3 is a block diagram of an afterimage preventive block according to an exemplary embodiment of the present invention.

The afterimage preventive block employs method of inserting an afterimage preventive pattern in the existing sub-field, and includes a memory 27, a signal generator 21, a timer 29, a sub-field selector 23 and a pattern inserter 25.

The memory 27 stores an afterimage preventive pattern to be inserted in the sub-field of the video signal. The afterimage preventive pattern may provided in many different configurations, and includes a white pattern in which all the phosphors are excited and the display 30 is expressed in white, a RGB alternating pattern in which red, green and blue phosphors are sequentially excited, or any appropriate pattern, such as a company logo, to prevent the afterimage.

The memory 27 may also store whether or not the afterimage preventive pattern is output. For example, n=1 may be stored if the afterimage preventive pattern is output, and n=0 may be stored if a specified time has passed after the output of the afterimage preventive pattern. Accordingly, if the memory 27 stores n=1, the pattern inserter 25 does not insert the afterimage preventive pattern, and if n=0 is stored, inserts the afterimage preventive pattern. In one exemplary implementation, it takes at least 100 Hz to change n=1 to n=0. Accordingly, re-insertion of afterimage preventive pattern within a 100 Hz interval can be prevented. While ordinary people usually do not recognize the video signal over 30 Hz, a few with acute vision may be able to do so. By preventing the re-insertion of afterimage preventive pattern within the interval of 100 Hz, inconvenience of these people can be avoided.

The signal generator 21 outputs a signal to select the sub-field to insert the afterimage preventive pattern. The signal generator 21 generates signal randomly, and with varying the period. The signal generator 21 may be a random-number generator.

The timer 29 counts a specified time, if the signal is output from the signal generator 21. The counted time information of the timer 29 is provided to the memory 27. If the counted time information exceeds a specified time, n=1 of the memory 27 is changed to n=0. The specified time may desirably be 100 Hz, the time which is taken until n=1 is changed to n=0.

The sub-field selector 23 selects one of a plurality of sub-fields of a plurality of frames of a video signal to be displayed to insert an afterimage preventive pattern. Upon generation of a signal from the signal generator 21, the sub-field selector 23 determines whether n=0 or n=1 is stored in the memory 27, and if n=0 is stored, selects a sub-field which is input at the moment that the signal is generated from the signal generator 21. However, if n=1 is stored in the memory 27 at the moment that the signal is generated from the signal generator 21, the sub-field selector 23 awaits until n=0 is changed. If n=1 is changed to n=0, the sub-field selector 23 may select a sub-field which is input at the moment of the change, or wait until the next signal is input from the signal generator 21 and select a sub-field upon generation of a signal from the signal generator 21.

By the implementation explained above, at least 100 Hz is taken until an afterimage preventive pattern is inserted, and accordingly, at least 4 to 12 afterimage preventive patterns may be inserted in one frame. However, considering that the signal generator 21 generates a signal randomly, it should be noted that there may be a frame in which an afterimage preventive pattern is not inserted.

The pattern inserter 25 inserts an afterimage preventive pattern in the selected sub-field. The pattern inserter 25 extracts one of a plurality of afterimage preventive patterns being stored in the memory 27, and inserts the extracted afterimage preventive pattern in the selected sub-field of the frame. After the afterimage preventive pattern is inserted at the pattern inserter 25, the frame is provided to the display 30 and displayed.

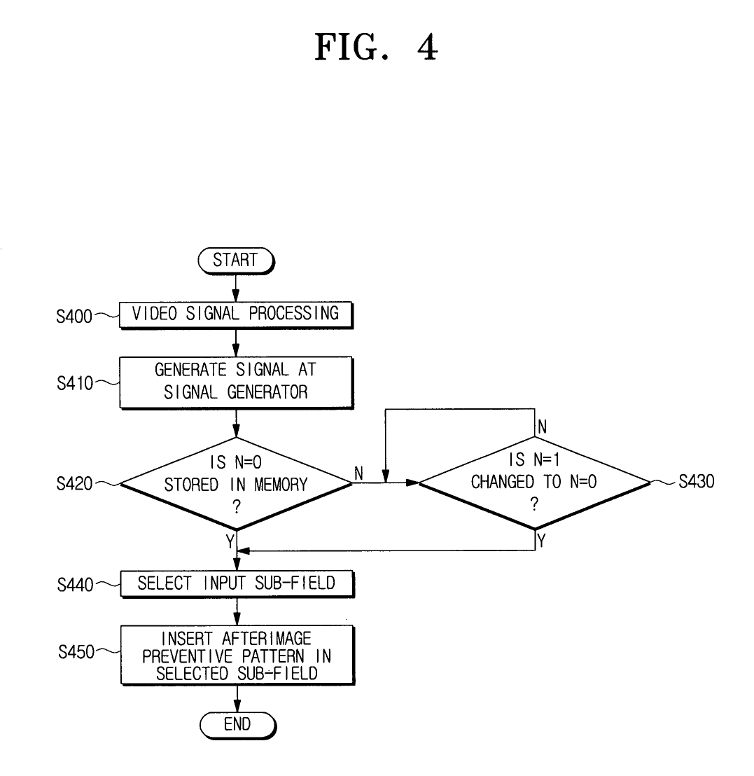

The process of preventing afterimage in the PDP constructed as above, will be explained in detail with reference to FIGS. 2 and 4.

First, a video signal is input, and the signal processor 10 processes the incoming video signal into a form available for output through the display 30 (S400). The sub-field selector 23 determines whether a signal is output from the signal generator 21 (S410), and if determining so, determines whether n=0 or n=1 is stored in the memory 27 (S420 and S430). If n=0 is stored in the memory 27 (S420-Y), the sub-field selector 23 selects an input sub-field (S440). If n=1 is stored, the sub-field selector 23 waits until n=1 is changed to n=0 (S430), and selects a sub-field which is input at the moment that n=1 is changed to n=0 (S440).

If a sub-field is selected, the pattern inserter 25 extracts an afterimage preventive pattern from the memory 27, and inserts the extracted pattern in the selected sub-field (S450). FIG. 2 illustrates an afterimage preventive pattern being inserted in the selected, second sub-field of the third frame. The video signal having a sub-field in which the afterimage preventive pattern is inserted, is provided to the display 30 and displayed.

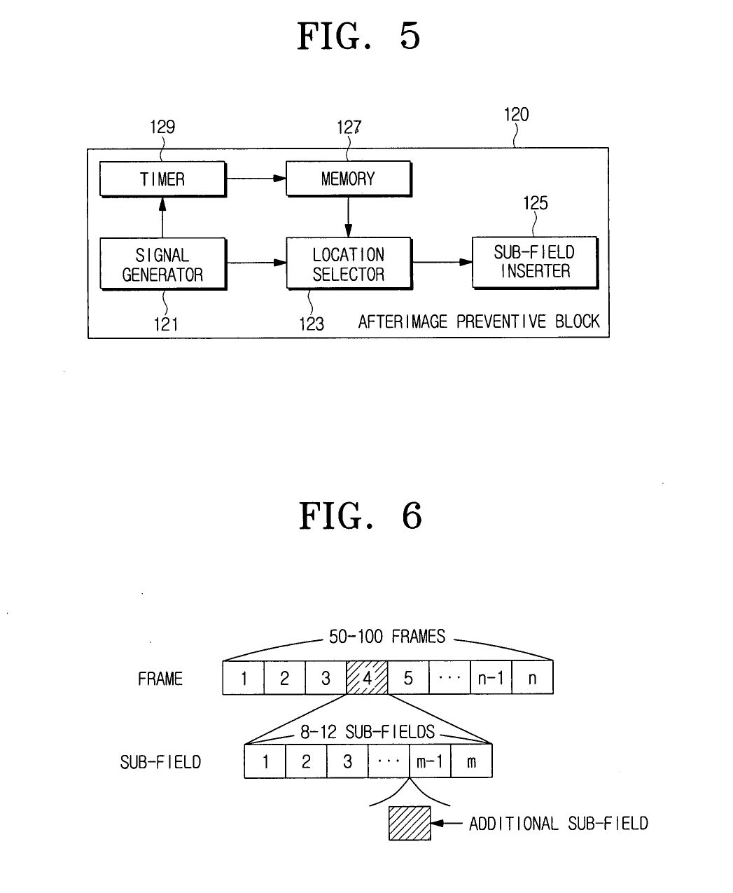

FIG. 5 is a block diagram of an afterimage preventive block according to another exemplary embodiment of the present invention.

The afterimage preventive block according to one aspect of the present invention operates to prevent afterimage, by inserting additional sub-field having an afterimage preventive pattern, and includes a memory 127, a signal generator 121, a timer 129, a location selector 123 and a sub-field inserter 125.

The memory 127 stores an afterimage preventive pattern to be inserted in the sub-field of the video signal, and information as to whether or not the sub-field having the afterimage preventive pattern is inserted. The memory 127 stores n=1, if a sub-field having the afterimage preventive pattern is inserted, and stores n=1 if a sub-field has been inserted and a specified time elapsed after the insertion of the sub-field. The sub-field inserter 125 does not insert the sub-field having the afterimage preventive pattern, if n=1 is stored in the memory 127, and inserts the sub-field having the afterimage preventive pattern, if n=0 is stored in the memory 127.

The operation of the signal generator 121 and the timer 129 are almost identical to those of the signal generator 21 and the timer 29 as explained above with reference to FIG. 3, and thus will not be explained in further detail for the sake of brevity.

The location selector 123 selects a location to insert a sub-field having an afterimage preventive pattern. The location selector 123 determines whether n=0 or n=1 is stored in the memory, if a signal is generated from the signal generator 121, and selects the location at the moment that the signal is generated from the signal generator 121, if n=0 is stored in the memory 127. However, if n=1 is stored in the memory 127 at the moment that the signal is generated from the signal generator 121, the location selector 123 waits until it changes to n=0. Upon change of n=1 to n=0, the location selector 123 may select the location at the moment that the change is made, or wait until the next signal is output from the signal generator 121 and select the location at the moment of the next output.

The sub-field inserter 125 extracts an afterimage preventive pattern from the memory 127 and inserts a sub-field having the afterimage preventive pattern in the selected location. After the afterimage preventive pattern is inserted at the sub-field inserting unit 125, the frame is provided to the display 30 and displayed.

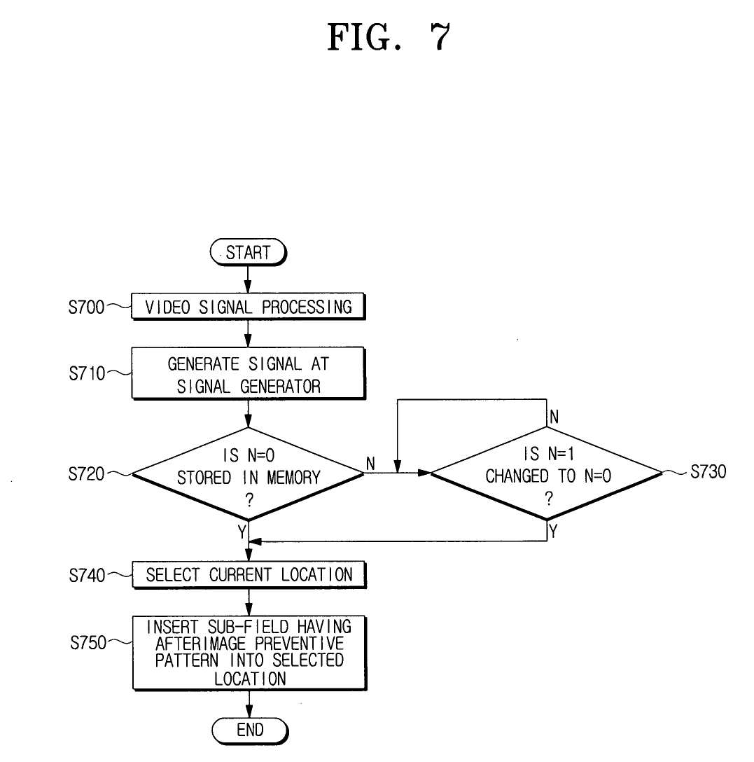

The process of preventing afterimage in the PDP according to an exemplary embodiment of the present invention will be explained below, with reference to FIGS. 6 and 7.

First, a video signal is input and the signal processor 10 processes the video signal into a form available for output through the display 30 (S700). The location selector 123 determines whether a signal is output from the signal generator 121 (S710), and if determining so, determines whether n=0 or n=1 is stored in the memory 127 (S720). If n=0 is stored in the memory 27 (S720-Y), the location selector 123 selects a location to insert a sub-field (S740). If n=1 is stored, the location selector 123 waits until n=1 is changed to n=0 (S730), and selects a location at the moment that n=1 is changed to n=0 (S740).

If a location is selected, the sub-field inserter 125 extracts an afterimage preventive pattern from the memory 127, and inserts the extracted sub-field in the selected location (S750). FIG. 6 illustrates a sub-field having an afterimage preventive pattern being inserted in the selected location which is immediately before the (m-1)th sub-field of the fourth frame. The video signal in which the sub-field having the afterimage preventive pattern is inserted, is provided to the display 30 and displayed.

In the exemplary embodiments explained above, sub-field to insert the afterimage preventive pattern, or the location to insert the additional sub-field, is selected randomly, using the signal generator 21, 121 and the timer 29, 129. However, other appropriate alternative examples may also be employed. For example, an afterimage preventive pattern or a sub-field may be inserted according to a specified time period.

As explained above, according to the exemplary embodiments of the present invention, an afterimage preventive pattern is inserted in a sub-field of a frame of a video signal being displayed on the PDP such that afterimage of the displayed signal can be prevented. Additionally, because the afterimage preventive pattern is inserted according to the timer period of 100 Hz or longer, viewers are not able to recognize the afterimage preventive pattern and therefore, usual drawbacks of the related art such as inconvenience, eye-fatigue, or distorted video, can be avoided.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art

What is claimed is:

1. A method of preventing an afterimage of a plasma display panel (PDP), the method comprising:
selecting at least one sub-field to insert an afterimage preventive pattern, among sub-fields of a plurality of frames of a video signal to be displayed;
inserting the afterimage preventive pattern to the selected sub-field; and
displaying, on a display, the frame containing the sub-field in which the afterimage preventive pattern is inserted.

2. The method of claim 1, wherein the selecting at least one sub-field comprises selecting the at least one sub-field according to a specified time period.

3. The method of claim 1, wherein the selecting at least one sub-field comprises selecting the sub-field randomly.

4. The method of claim 2, wherein the selecting at least one sub-field comprises:
generating a signal to select the sub-field according to the specified time period;
measuring a time to the next signal, if the signal is generated;
determining if the measured time exceeds the specified time period; and
selecting the sub-field at the moment that the signal is generated, if the measured time exceeds the specified time period.

5. The method of claim 4, further comprising selecting the sub-field after the specified time period elapses, if the measured time does not exceed the specified time period.

6. A method of preventing an afterimage of a plasma display panel (PDP), the method comprising:
selecting a location in a frame to insert an afterimage preventive pattern, from at least one of a plurality of frames of a video signal to be displayed;
inserting a sub-field having the afterimage preventive pattern in the selected location; and
displaying on a display, the frame in which the sub-field having the afterimage preventive pattern is inserted.

7. The method of claim 6, wherein the selecting the location to insert the afterimage preventive pattern comprises selecting the location every time a specified time period elapses.

8. The method of claim 6, wherein the selecting the location to insert the afterimage preventive pattern comprises:
generating a signal to select a location to insert the sub-field, according to a specified time period;
measuring a time to the next signal, if the signal is generated; and
selecting a location to insert the sub-field, if the measured time exceeds the specified time period.

9. The method of claim 8, further comprising selecting a location to insert the sub-field at a time that the measured time reaches the specified time period, if the measured time does not exceed the specified time period.

10. A plasma display panel (PDP), comprising:
a sub-field selector which selects at least one sub-field to insert an afterimage preventive pattern, among sub-fields of a plurality of frames of a video signal to be displayed;
a pattern inserter which inserts the afterimage preventive pattern to the selected sub-field; and
a display which displays the frame containing the sub-field in which the afterimage preventive pattern is inserted.

11. The PDP of claim 10, wherein the sub-field selector selects the at least one sub-field according to a specified time period.

12. The PDP of claim 10, wherein the sub-field selector selects the at least one sub-field randomly.

13. The PDP of claim 12, further comprising:
a signal generator which generates a signal to select the sub-field according to a specified time period; and
a timer which measures A time from the generation of the signal until the next signal, wherein
the sub-field selector, upon determination that the signal is generated from the signal generator, selects the sub-field if the measured time exceeds the specified time, and selects the sub-field after the specified time elapses, if the measured time does not exceed the specified time.

14. The PDP of claim 13, further comprising a memory which stores the afterimage preventive pattern, and wherein the pattern inserter inserts the afterimage preventive pattern being stored in the memory into the selected sub-field and provides the display with the afterimage preventive pattern.

15. The PDP of claim 10, further comprising a memory which stores the afterimage preventive pattern, and wherein the pattern inserter inserts the afterimage preventive pattern being stored in the memory into the selected sub-field and provides the display with the afterimage preventive pattern.

16. The PDP of claim 10, wherein the afterimage preventive pattern comprises at least one of a full white (F/W) pattern in which the entire screen is represented in white, a red, green, blue (RGB) alternating pattern in which red, green and blue are alternatively expressed, and a company logo pattern.

17. A plasma display panel (PDP), comprising:
a location selector which selects a location to insert a sub-field having an afterimage preventive pattern, from at least one of a plurality of frames of a video signal to be displayed;
a sub-field inserter which inserts the sub-field having the afterimage preventive pattern into the selected location; and
a display which displays the frame in which the sub-field having the afterimage preventive pattern is inserted.

18. The PDP of claim 17, wherein the location selector selects the location to insert the sub-field, according to a specified time period.

19. The PDP of claim 17, wherein the location selector selects the location to insert the sub-field, randomly.

20. The PDP of claim 19, further comprising:
a signal generator which generates a signal to select the location to insert the sub-field having the afterimage preventive pattern, according to a specified time period; and
a timer which measures a time until the next signal, if a signal is output from the signal generator,
wherein the location selector, upon determination that the signal is generated from the signal generator, selects the location to insert the sub-field having the afterimage preventive pattern, if the measured time exceeds the specified time, and waits until the specified time elapses and selects the location to insert the sub-field having the afterimage preventive pattern, if the measured time does not exceed the specified time.

21. The PDP of claim 20, further comprising a memory which stores the afterimage preventive pattern, and wherein the sub-field inserter inserts the afterimage preventive pattern being stored in the memory into the selected location and provides the display with the afterimage preventive pattern.

22. The PDP of claim 17, further comprising a memory which stores the afterimage preventive pattern, and wherein the sub-field inserter inserts the afterimage preventive pattern being stored in the memory into the selected location and provides the display with the afterimage preventive pattern.
